(19) United States
(12) Patent Application Publication
(10) Pub. No.: US 2026/0216805 A1
(43) Pub. Date: Jul. 30, 2026

(54) SEMI AUTONOMOUS CUTTING ELEMENT BRAZING SYSTEM

(71) Applicant: Schlumberger Technology Corporation, Sugar Land, TX (US)

(72) Inventors: Youhe ZHANG, Houston, TX (US); Huimin SONG, Houston, TX (US); Xiaoge GAN, Houston, TX (US); Weicheng ZHANG, Spring, TX (US); Ting REN, Houston, TX (US); Mingdong CAI, Houston, TX (US); Yuri BURHAN, Houston, TX (US)

(21) Appl. No.: 19/142,986

(22) PCT Filed: Dec. 20, 2023
(86) PCT No.: PCT/US2023/085179

§ 371 Date: Jun. 25, 2025

Related U.S. Application Data
(60) Provisional application No. 63/477,610, filed on Dec. 29, 2022.

(51) Int. Cl. B23K 1/002; B23K 1/00; B23K 101/20

(52) U.S. Cl. CPC B23K 1/002; B23K 1/0008; B23K 2101/20

(57) ABSTRACT

A method of bonding a cutting element to a downhole drilling tool includes orienting an induction coil with respect to a cutting element pocket and applying an energy input to the induction coil to heat the cutting element pocket to a brazing temperature. The method further includes determining a pocket temperature of the cutting element pocket and, based on the pocket temperature, controlling the energy input to the induction coil to maintain the pocket temperature at the brazing temperature for a brazing period.

### CROSS-REFERENCE TO RELATED APPLICATIONS

This application claims the benefit of U.S. Provisional Application No. 63/477,610, entitled “SEMI AUTONOMOUS CUTTING ELEMENT BRAZING SYSTEM,” filed Dec. 29, 2022, the disclosure of which is hereby incorporated herein by reference.

### BACKGROUND OF THE DISCLOSURE

Wellbores may be drilled into a surface location or seabed for a variety of exploratory or extraction purposes. For example, a wellbore may be drilled to access fluids, such as liquid and gaseous hydrocarbons, stored in subterranean formations and to extract the fluids from the formations. Wellbores used to produce or extract fluids may be formed in earthen formations using earth-boring tools such as drill bits for drilling wellbores and reamers for enlarging the diameters of wellbores.

An earth-boring tool may include one or more cutting elements thereon. Typically, the tool includes one or more cutter pockets on an outer surface of the tool body, and the cutting elements are secured within the pockets by brazing. The tool body and the cutting elements are typically fabricated separately and may be formed from different materials. The high temperatures at which brazing occurs can change the physical properties of the materials which may lead to cracking, failed connections, premature wearing, and so forth. Additionally, manual brazing can be labor intensive and time consuming, which also leads to the inconsistency in braze joint quality and therefore negatively impacts the structural integrity.

### SUMMARY

In some embodiments, a method of bonding a cutting element to a downhole drilling tool includes orienting an induction coil with respect to a cutting element pocket, applying an energy input to the induction coil to heat the cutting element pocket to a brazing temperature, determining a pocket temperature of the cutting element pocket, and, based on the pocket temperature, controlling the energy input to the induction coil to maintain the pocket temperature at the brazing temperature for a brazing period.

In some embodiments, a method of bonding a cutting element to a downhole drilling tool includes applying a brazing material to a cutting element pocket, inserting a cutting element into the cutting element pocket, orienting a robotic arm with respect to the cutting element pocket, the robotic arm including an induction coil, orienting the induction coil adjacent to the cutting element pocket, applying an energy input to the induction coil to heat the cutting element pocket to a brazing temperature, while at the brazing temperature, melting the brazing material, and after melting the brazing material, pushing the cutting element into the cutting element pocket while maintaining an angular orientation of the cutting element.

In some embodiments, a brazing system includes a robotic arm having a working end, an induction heater connected to the working end of the robotic arm, a bit body positioned relative to the robotic arm, and a thermal sensor oriented toward a brazing site.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is an example of a drilling system, according to at least one embodiment of the present disclosure;

FIG. 2 is a perspective view of the downhole end of an embodiment of a bit, according to at least one embodiment of the present disclosure;

FIG. 3 is a diagram of a brazing system, according to at least one embodiment of the present disclosure;

FIG. 4-1 is a perspective view of a brazing system, according to at least one embodiment of the present disclosure;

FIG. 4-2 is a side cross-sectional view of the brazing system of FIG. 4-1;

FIGS. 4-3 and 4-4 are front views of the brazing system of FIG. 4-1;

FIG. 5 is a perspective view of a brazing system, according to at least one embodiment of the present disclosure;

FIG. 6 is a flow diagram of a method of using a brazing system, according to at least one embodiment of the present disclosure; and

FIG. 7 is a flow diagram for implementing a control loop in conjunction with a brazing system, according to at least one embodiment of the present disclosure.

### DETAILED DESCRIPTION

This disclosure generally relates to devices, systems, and methods for attaching abrasive elements to earth-boring tools. For example, a cutting element may be brazed to a drilling tool through the use of a brazing system. In some embodiments, the brazing system may include an induction heater that may generate a magnetic field to form a brazing zone within a portion of the drilling tool. The brazing system may direct the brazing zone at a cutting element and/or a cutting element pocket, and may thereby braze the cutting element to the cutting element pocket without damaging the cutting element and/or the cutting element pocket. For example, the brazing system may control an energy input to the induction heater to control the location and magnitude of heating of the drilling tool. The brazing system may focus the brazing zone to a localized portion of the drilling tool. Control of the energy input may reduce or eliminate damage to the cutting element pocket and/or the cutting element due to sustained heating or overheating. In some embodiments, the brazing system may be semi-autonomous and may braze a cutting element in 60 seconds or less. This may reduce the amount of time and complexity to finish a drilling tool with one or more cutting elements. In this way, a brazing system as described herein may have advantages over conventional methods of brazing a cutting element to a drilling tool.

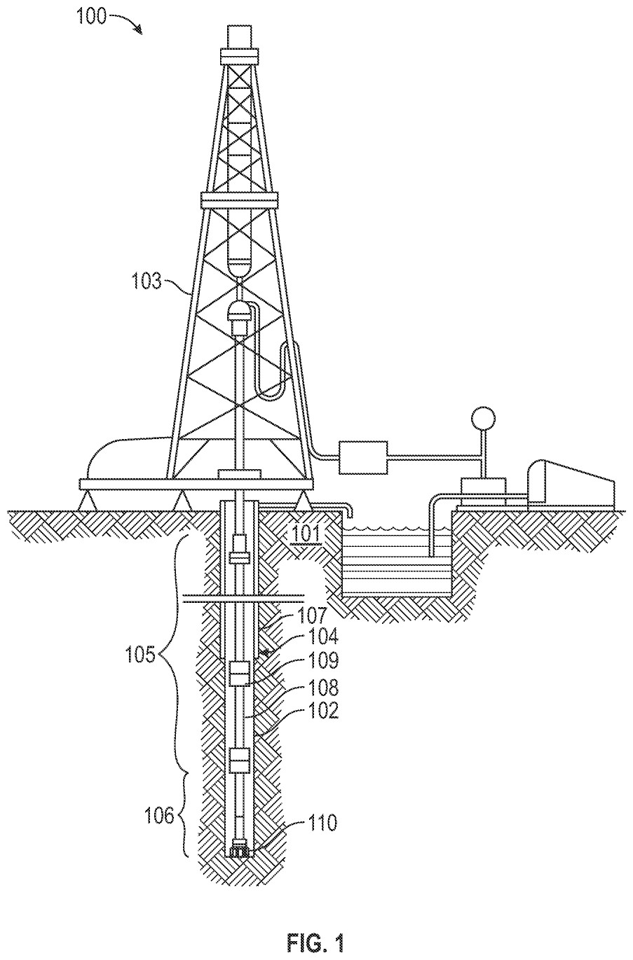

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional downhole drilling tools and/or components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110, other downhole drilling tools, or other components. An example BHA 106 may include additional or other downhole drilling tools or components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other downhole drilling tools, components, and accessories such as special valves (e.g., kelly cocks, blowout preventers, and safety valves). Additional components included in the drilling system 100 may be considered a part of the drilling tool assembly 104, the drill string 105, or a part of the BHA 106, depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to the surface, or may be allowed to fall downhole. The bit 110 may include one or more cutting elements for degrading the earth formation 101. When the cutting elements engage the borehole, the cutting elements may experience different forces, pressures, shocks, and so forth. The cutting elements may be brazed to the bit 110 to form a brazed connection. The brazed connection may provide a secure connection of the cutting elements to the bit 110 to withstand the downhole environment.

Conventionally, brazing may be performed manually and may be labor intensive and/or time consuming. Conventional brazing may be imprecise and may result in damage to the cutting elements and/or the bit 110 due to overheating and/or prolonged heating. In accordance with at least one embodiment of the present disclosure, the cutting elements may be brazed to the bit 110 by a brazing system. In some embodiments, the brazing system may include an induction heater positionable or movable by a robotic arm. The brazing system may heat the cutting elements and/or the bit 110 with the induction heater and thereby braze the cutting elements to the bit 110. In some embodiments, the brazing system may control an energy input to the induction heater and/or localize the heating by the induction heater, and thereby avoid damage to the cutting elements and/or the bit 110. In some embodiments, the brazing system may be semi-autonomous and may braze the cutting element in 60 seconds or less. In this way, the brazing system may braze the cutting elements to the bit 110 with significant advantages over conventional methods.

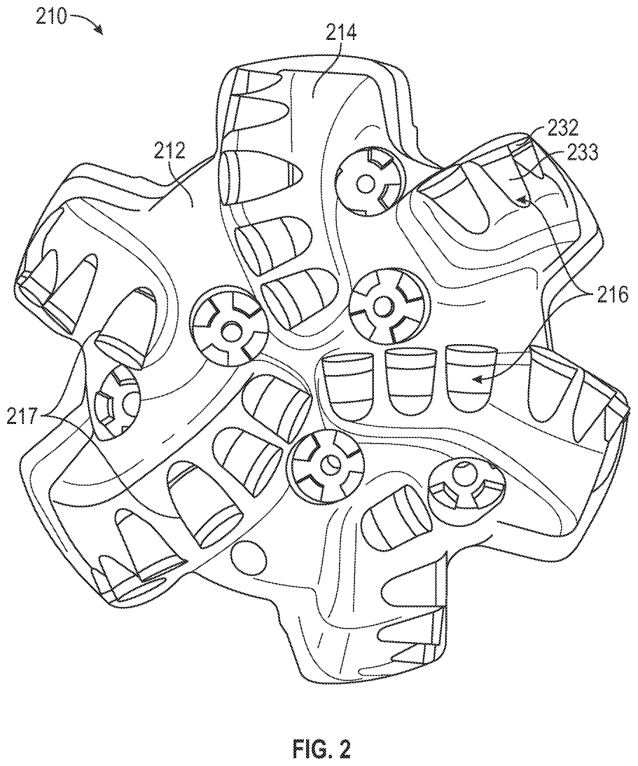

FIG. 2 is a perspective view of the downhole end of an embodiment of a bit 210. For example, the bit 210 may be a downhole drilling tool such as any of the downhole drilling tools discussed herein in connection with FIG. 1. The bit 210 may include a bit body 212 from which a plurality of blades 214 may protrude. At least one of the blades 214 may have a plurality of cutting elements 216 connected thereto. In some embodiments, at least one of the plurality of cutting elements 216 may be a planar cutting element, such as a shear cutting element. In other embodiments, at least one of the plurality of cutting elements 216 may be a non-planar cutting element, such as a conical cutting element, a ridged cutting element, or a scooped cutting element.

The cutting elements 216 may be positioned and oriented to engage an earthen formation during underground drilling operations. The cutting elements 216 may encounter objects and/or materials in the earthen formation that may exhibit varying levels of hardness, abrasive properties, toughness, resilience, and so forth. Such operations may subject the cutting elements 216 to many temperatures, pressures, forces, torques, impacts, and so forth that are different than those at the surface. These operational parameters may create conditions and forces that may dislodge the cutting elements 216 from the blade 214.

The blade 214 may have a plurality of cutting element pockets 217 formed into the body of the blade 214. The bit body 212, including the blades 214, may be formed from a matrix of infiltrated hard particles, such as tungsten carbide (WC) particles infiltrated with a metallic binder. In some embodiments, the bit body 212, including the blades 214, may be formed from steel. For example, the bit body 212 and the blades 214 may be machined from one or more steel blanks. Moreover, composite bits may have components (e.g., blades, blade faceplates, blade covers) formed from a matrix material, and other components (e.g., bit body, blades) formed from a solid material (e.g., steel, aluminum). The cutting element pocket 217 may be formed in the blades 214. The cutting element 216 may be inserted into the cutting element pocket 217 and secured to the blade 214 at the cutting element pocket 217. In some embodiments, the cutting element 216 may be secured to the blade 214 by a brazing system, as described in further detail herein.

In some embodiments, a cutting element 216 may be formed of an ultrahard portion 232 bonded or connected to a substrate 233. The ultrahard portion 232 may be located on a distal end of the cutting element 216, or on an end of the cutting element opposite an end where the cutting element 216 may be attached to the cutting element pocket 217. The ultrahard portion may be any ultrahard or superhard material, such as polycrystalline diamond (PCD). The substrate 233 may be cemented tungsten carbide, or a tungsten carbide metal matrix.

The cutting element 216 may be connected to the blade 214 by brazing the cutting element 216 in the cutting element pocket 217 (e.g., the cutting element 216 may be connected to the blade 214 with a brazed connection). During the brazing process, a filler material may be heated to bond with the cutting element 216 and the cutting element pocket 217. The filler material includes a brazing material and optionally a flux material. The brazing material may be a metal or a metallic alloy that may bond with both the cutting element 216 and the cutting element pocket 217. The flux material may be an anti-oxidizing material that may coat the cutting element 216 and/or the cutting element pocket 217 to prevent oxidation of the material of the cutting element 216 and/or the cutting element pocket 217 during heating.

While brazing, the cutting element 216 and/or the cutting element pocket 217 (e.g., the material of the blade 214 surrounding the cutting element pocket 217) may be heated. The brazing material may be heated directly from the brazing system and/or indirectly heated from the heating of the cutting element 216 and cutting element pocket 217. The brazing material may melt and flow between the cutting element 216 and the cutting element pocket 217 to fill the space between the cutting element 216 and the cutting element pocket 217. In some embodiments, the brazing material may flow through the space using capillary action. In some embodiments, the brazing material may flow through the space through any other mechanism.

The brazing material has a brazing temperature at which the brazing material may melt and flow through the space. In some embodiments, the space between the cutting element 216 and the cutting element pocket 217 is an annular space. In some situations, brazing material may be selected to have a brazing temperature that is less than a melting or otherwise harmful temperature of the blade 214 and/or the cutting element 216. For example, the brazing temperature may be approximately 1300° F. Overheating of the materials composing the bit body 212, the blade 214, and/or the cutting element 216 may change their material properties. For example, overheating the bit body 212, the blade 214, and/or the cutting element 216 may change their internal structures. In some situations, overheating may damage the bit body 212, the blade 214, and/or the cutting element 216. For example, overheating to a critical temperature of 1450° F. or greater may cause damage to the bit body 212, the blade 214, and/or the cutting element 216. In some examples, heating of the metal matrix and/or ultrahard portion 232 of the cutting element 216 may cause at least a portion of the cutting element 216 to crack, to become brittle, to lose its abrasive and/or wear resistant properties, or otherwise damage the cutting element 216.

Conventionally, brazing may be performed manually by a skilled operator heating the blade 214 and/or cutting element 216 with an oxyacetylene torch and applying the brazing material to the space between the cutting element 216 and the cutting element pocket 217. Inconsistencies and/or human error may lead to the blade 214 and/or the cutting element 216 reaching or exceeding the critical temperature which may damage or reduce the effectiveness of these components. The flame temperature of an oxyacetylene torch or other torch utilized for brazing may exceed a critical temperature for the blade 214 and/or cutting element 216 such that precise heating of the blade 214 and/or the cutting element 216 is difficult. Intermittent application of a flame for brazing may be complex and imprecise. It may be difficult to determine the internal temperature of the blade 214 and/or cutting element 216 during traditional brazing. For example, skilled operators may identify a particular metal color, pattern, or visual characteristic to determine the approximate temperature of the blade 214. In some embodiments, thermal sensors may become blinded or obscured by the flame from an oxyacetylene torch. As a result, it may be difficult or even impossible to accurately detect and control the temperature of the blade 214. This may result in damage to the blade 214, damage to the cutting element 216, reduced quality of the braze, otherwise damage to the bit 210, and combinations thereof.

In some situations, brazing of the cutting element 216 to the blade 214 may be time consuming and/or labor intensive. For example, hand brazing a bit with multiple cutting elements through traditional brazing methods may last hours. A brazing system as described herein may significantly reduce the amount of time and resources it takes to finish a bit. For example, the brazing system may include an induction heater movable and controllable by a robotic arm. The brazing system may move the induction heater along a heating path corresponding to the geometry of the blades 214. The brazing system may control the energy input into the induction heater to braze one or more cutting elements 216 positioned along the heating path. In some embodiments, the brazing process for an individual cutting element 216 may occur in less than 60 seconds. In some embodiments, the brazing system may be semi-autonomous and may braze multiple cutting elements 216 to the bit 210 by performing one or more functions autonomously and an operator may perform one or more functions manually. In this way, the brazing system may braze one or more cutting elements 216 to the bit 110 in a quick and efficient manner.

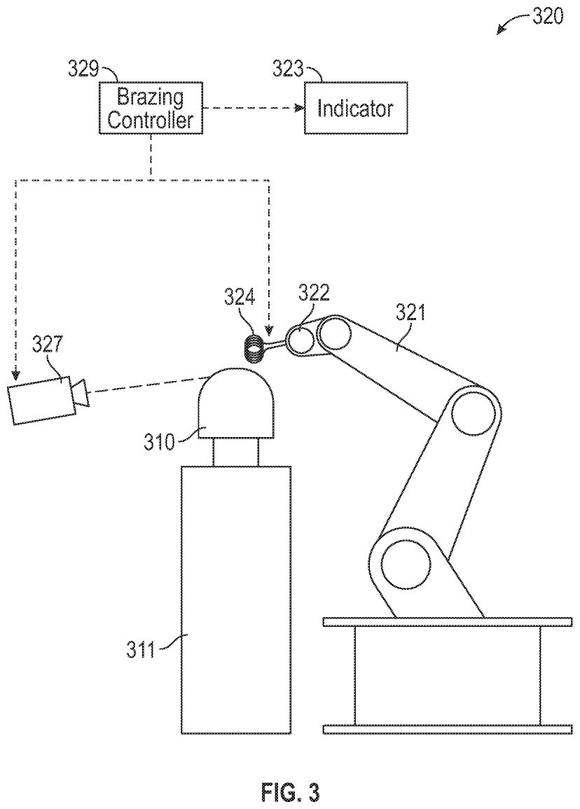

FIG. 3 shows an example of a brazing system 320 for bonding or attaching a cutting element to a bit 310, according to at least one embodiment of the present disclosure. The brazing system 320 may include a robotic arm 321 with a working end 322. The robotic arm 321 may move with three or more degrees of freedom such that it may move and/or manipulate the working end 322 in 3-dimensional space. In some embodiments, the robotic arm 321 may be autonomous. For example, the robotic arm 321 may move and/or orient the working end 322 according to a pre-programmed path. In some embodiments, the robotic arm 321 may be nonautonomous. For example, the robotic arm 321 may be manipulated by an operator controlling the robotic arm 321. In some embodiments, the robotic arm 321 may be semi-autonomous. For example, the robotic arm may move and/or orient the working end 322 according to a pre-programmed path subject to input or control by an operator at one or more stages of operation of the robotic arm 321.

The brazing system 320 may include a bit support 311. A bit 310 may be connected to or supported by the bit support 311. In some embodiments, the robotic arm 321 may be located relative to and associated with the bit support 311 to allow the robotic arm 321 access to the bit 310. For example, the bit support 311 and the bit 310 may be fixed and the robotic arm 321 may move and/or orient the working end 322 with respect to the bit 310. In other words, the working end 322 may be movable or positionable relative to the bit 310. The brazing system 320 may include an induction heater 324. The induction heater 324 may be connected to the working end 322 of the robotic arm 321. The robotic arm 321 may move and/or manipulate the induction heater 324 according to the movements and/or manipulations of the working end 322. For example, the robotic arm 321 may position and/or orient the induction heater 324 relative to the bit 310 connected to the bit support 311. In other words, the induction heater 324 may be movable or positionable relative to the bit 310. This may allow the robotic arm 321 to move the induction heater 324 to any portion of the bit 310.

In some embodiments, the bit support 311 may be connected to the working end 322 of the robotic arm 321, and the robotic arm 321 may move and/or manipulate the bit support 311. The induction heater 324 may be in a fixed position, and the robotic arm 321 may move and/or orient the working end 322 holding the bit support 311 and the bit 310 with respect to the induction heater 324. Put another way, the robotic arm 321 may position and/or orient the bit 310 relative to the induction heater 324.

In some embodiments, the brazing system 320 may include a plurality of robotic arms 321. The bit support 311 may be connected to one of the robotic arms 321 and the induction heater 324 may be connected to another of the robotic arms 321. This may allow the bit support 311 and the induction heater 324 to independently move. This may help to improve the flexibility and/or positionability of the bit support 311 and/or the induction heater 324 with respect to each other.

The induction heater 324 may include an induction coil. Upon application of an electric current, the induction heater 324 may generate a magnetic field. The magnetic field generated by the induction heater 324 may be modulated based on an electrical energy input to the induction heater 324. For example, the robotic arm 321 may position the induction heater 324 adjacent or in close proximity to the bit 310, and the induction heater may generate a magnetic field that is oriented through a portion of the bit 310. Put another way, the robotic arm 321 may position the induction heater 324 such that at least a portion of the bit 310 may be positioned within the magnetic field generated by the induction heater 324. The magnetic field may induce an electric current in the portion of the bit 310 located within the magnetic field. Based on the conductivity and/or resistance of the material in the magnetic field and the strength of the magnetic field, this induced current may cause the portion of the bit 310 to heat up. That is, induced electric currents (e.g., eddy currents) within the portion of the bit 310 caused by the magnetic field may heat up the portion of the bit 310 due to resistive heating.

The magnetic field may result in a brazing zone in the portion of the bit 310 that experiences heating from the induced electric current. A portion of the bit 310 located outside of the brazing zone may experience reduced or no heating from the induced electric current. A portion of the bit 310 located outside the brazing zone may experience indirect heating, such as thermal conduction from the portion of the bit 310 located within the brazing zone. In this way, the inductive heating effect of the applied magnetic field may target, be localized to, or otherwise be directed at a specific portion of the bit 310, or a brazing site. Localized heating may help to reduce the amount of time a portion of the bit 310 is at the brazing temperature, which may help to reduce or prevent damage to the bit 310.

The intensity of the magnetic field may be controlled by the electrical energy input to the induction heater 324. The intensity of the magnetic field may correspond to the degree of heating that an object in the magnetic field experiences due to the induced electric current. For example, the induction heater 324 may inductively heat the brazing site to a first temperature, and changing the electrical energy input to the induction heater 324 may change the magnetic field applied to the brazing site to inductively heat the brazing site to a second temperature that is different than the first temperature. Control of the magnetic field applied to the brazing site controls the induced electric current through the brazing site, thereby controlling the heating of the brazing site via the induced electric current. For example, increasing the strength or intensity of the magnetic field from the induction heater 324 may increase the rate at which the brazing site is heated and/or increase the size of the brazing site. The strength or intensity of the magnetic field (and thereby the induced electric current) may be controlled by adjusting the frequency and amplitude of an alternating current supplied to the induction heater 324. Put another way, a desired temperature of the brazing site may be reached by controlling the electrical energy input to the induction heater 324. In this way, in conjunction with the positioning of the induction heater 324, the temperature and location of the brazing site may be finely controlled.

The brazing system 320 may include one or more thermal sensors 327. The thermal sensor 327 may be any type of thermal sensor, such as an infrared camera, a thermocouple, thermistor, resistance temperature detector (RTD), any other thermal sensor, and combinations thereof. The thermal sensor 327 may be oriented and/or directed at the bit 310. The thermal sensor 327 may be oriented and/or directed at the brazing site. In this way, the thermal sensor 327 may be configured to determine a temperature of one or more portions of the bit 310. In some embodiments, the thermal sensor 327 may be oriented and/or directed at the bit 310 and may determine a temperature of multiple portions of the bit 310. For example, the thermal sensor 327 may determine a temperature of at least a portion of the brazing site, a portion of the bit 310 not within the brazing zone of the magnetic field, a cutting element of the bit 310, an ultrahard portion of the cutting element of the bit 310, a cutting element pocket of the bit 310, the induction heater 324, any other location, and combinations thereof. In some examples, a field of view of the thermal sensor 327 may capture an entirety of the bit 310. For example, the field of view of the sensor may capture an entire surface of the bit 310 viewable to the thermal sensor at the given orientation and/or angle of the thermal sensor relative to the bit 310. In another example, the field of view of the sensor may capture an entirety of a leading edge and/or a surface of a blade of the bit 310. In some embodiments, the thermal sensor 327 may be oriented at multiple locations of the bit 310 simultaneously. For example, multiple locations of the bit 310 may be detectable within the same field of view or sensor range of the thermal sensor 327. In another example, the thermal sensor may include multiple sensors at different orientations with respect to the bit 310, and the thermal sensor may capture a field of view including sensor inputs from any number of orientations and/or angles relative to the bit 310.

In some embodiments, the thermal sensor 327 may be oriented and/or directed at the brazing site and the induction heater 324. For example, the thermal sensor 327 may determine a surface temperate of one or more portions of the bit 310 while it is also directed at and/or observing the induction heater 324. Because the induction heater 324 itself is not significantly heated by the applied electrical energy and does not use a direct heat source (such as a flame), directing the thermal sensor 327 at and/or observing the induction heater 324 at the same time as the brazing site may not affect the ability of the thermal sensor 327 to detect temperatures of one or more portions of the bit 310. This may help to increase the precision of the control of the temperature of the bit body, the blade, the cutting elements, or other elements of the bit 310. In this manner, the induction heater 324 in combination with the thermal sensor 327 may help to improve the speed and/or quality of the brazing process.

In some embodiments, the thermal sensor 327 and the induction heater 324 may each be in communication with a brazing controller 329. For example, the brazing controller 329 may be a processor and memory in electronic communication with the thermal sensor 327 and the induction heater 324. The brazing controller 329 may receive data from the thermal sensor 327. Using the data from the thermal sensor 327, the brazing controller 329 may control an electrical energy input to the induction heater 324. The brazing controller 329, the thermal sensor 327, and the induction heater 324 may form a control loop, and the heating effect of the induced electric current from the magnetic field may be monitored and regulated through the control loop. In this manner, the control loop may help to improve the speed and/or quality of the brazing process by accurately controlling the temperature of the bit 310.

In some embodiments, the brazing system 300 may include an indicator 323. The indicator 323 may include, but is not limited to a graphical display, one or more lights, a speaker, or any combination thereof. The indicator may be coupled to the brazing controller 329 to provide an indication to an operator of one or more conditions of the brazing process. For example, the indicator 323 may be a temperature indicator and may provide a temperature indication of a blade, a cutting element, a cutting element pocket, an ultrahard portion of a cutting element, the induction heater, or any other component. In some embodiments, the indicator 323 may provide a signal to the operator that a cutter pocket is at a desired temperature for insertion of a cutting element with the brazing material. In some embodiments, the indicator 323 may provide signals to the operator corresponding to the temperatures of one or more locations of the bit 310. Additionally, or in the alternative, the indicator 323 may provide a signal to the operator that the robotic arm 321 is moving or will move along a brazing path. The indicator 323 may indicate any other condition related to the brazing process as described herein.

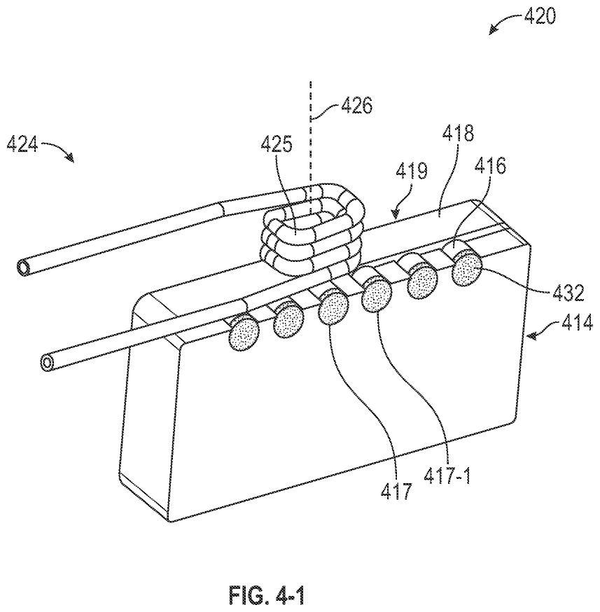

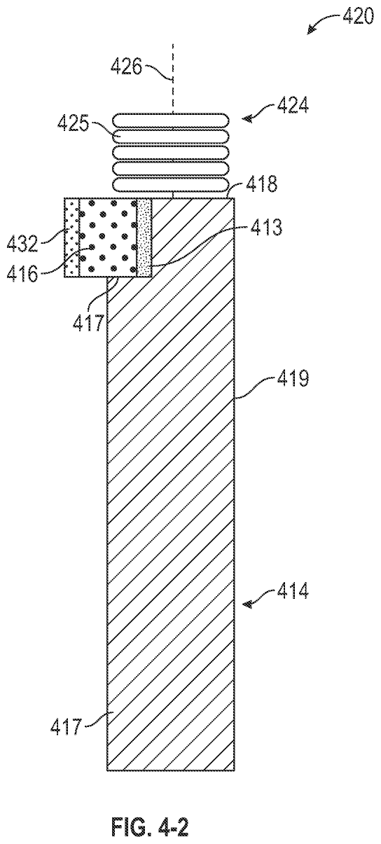

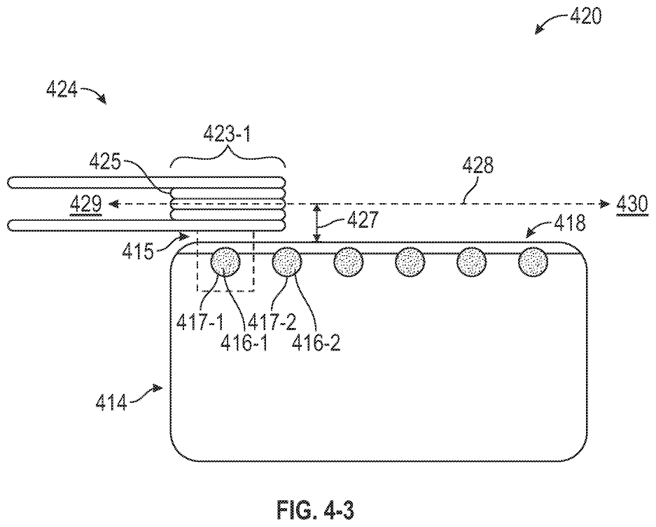

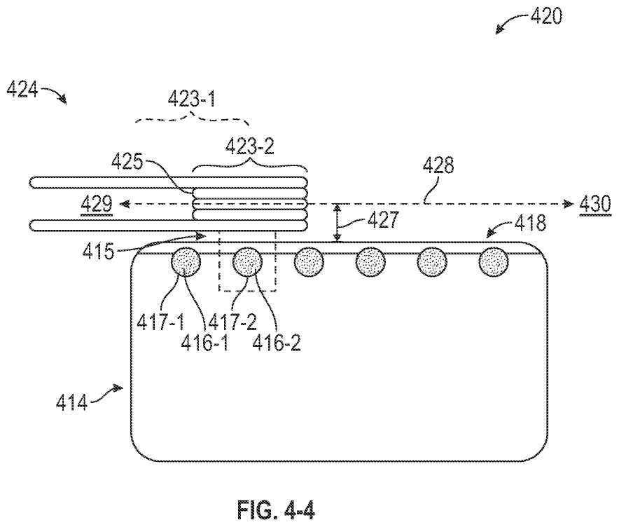

FIG. 4-1 shows a perspective view of a brazing system 420, according to at least one embodiment of the present disclosure. The brazing system 420 may include an induction heater 424, a blade 414, and a cutting element 416. The blade 414 may be any type of blade. For example, the blade 414 may be a blade on a bit such as the blade 214 on the bit 210 as discussed herein in connection with FIG. 2. In some examples, the blade 414 may be a blade on a reamer or stabilizer. In some examples, the blade 414 may be a blade on a casing cutter. In some examples, the blade 414 may be a free-standing blade. In some examples, the blade 414 may be a coupon, or sample blade used for testing. In some examples, the blade 414 may be any other base or support to which a cutting element or other insert may be brazed. The blade 414 may include one or more cutting element pockets 417.

The cutting element 416 may include an ultrahard portion 432. In the embodiment shown, the cutting element 416 is substantially cylindrical with a cutting face that is planar. However, it should be understood that the cutting element 416 may have any other geometry. The cutting element pocket 417 may be formed as a substantially cylindrical cavity in the body of the blade 414. In this way, the cutting element pocket 417 may accept the cutting element 416 for attachment to the blade 414. In other words, the cutting element 416 with a substrate having a shape may be inserted into the cutting element pocket 417 having a complementary shape.

The blade 414 may have a first side 418 and a second side 419. The first side 418 may be a top side of the blade 414. For example, the first side 418 may be a side of the blade 414 associated with an exposed portion of the cutting element 416 as shown in FIG. 4-1. The first side 418 may be adjacent to the second side 419. The second side 419 may be a back side of the blade 414. For example, the second side 419 may be a side of the blade that is an opposite side from the ultrahard portion 432 of the cutting element 416 as shown in FIG. 4-1.

The induction heater 424 shown includes an induction coil 425. In the embodiment shown in FIG. 4-1, a coil axis 426 through the center of the induction coil 425 is substantially perpendicular to or at a 90° angle relative to the first side 418. In some embodiments, the coil axis 426 may be at an angle relative to the first side 418 that is not 90°. For example, an angle between the coil axis 426 and the first side 418 may be substantially 0° such that the coil axis 426 is substantially parallel to the first side 418 and/or perpendicular to the second side 419. The coil axis 426 may be oriented at any other angle relative to the first side 418 and/or the second side 419.

As described herein, electrical energy passing through the induction coil 425 may generate a magnetic field that induces electric current in the blade 414. At least a portion of the magnetic field extends through the induction coil 425 along the coil axis 426, such that the magnetic field extends through objects positioned near the induction coil 425 and the coil axis 426. The induction coil 425 may be coupled to a robotic arm and the robotic arm may move and/or orient the induction coil 425 with respect to the blade 414. In this way, the brazing system 420 may orient the induction coil to target or be oriented at a brazing site and form a brazing zone. In some embodiments, the induction coil 425 may heat a localized portion of the blade 414. For example, the heating effect of the electric current induced by the magnetic field may be focused on a portion of the first side 418 and/or the second side 419 that corresponds to the cutting element pocket 417. In this way, the heating effect of the electric current induced by the magnetic field may be focused on and localized to the cutting element pocket 417. Rather than heating the blade by application of an external heat source (i.e., torch), the induced electric current generates heat via resistive heating within the blade 414 itself and/or cutting element 416 itself. This may cause at least a portion of the cutting element pocket 417 to increase in temperature. Adjacent portions of the blade 414 and/or the cutting element 416 outside the brazing zone may experience reduced or no heating by the induction heater 424.

The induction heater 424 may heat the cutting element pocket 417, the cutting element 416, and the brazing material to a brazing temperature. In some embodiments, the induction heater 424 indirectly heats the brazing material to the brazing temperature through heating of the cutting element pocket 417 and/or the cutting element through the electric current induced by the magnetic field. Direct or indirect heating of the brazing material may cause the brazing material to melt, thereby entering gaps between the cutting element 416 and the cutting element pocket 417, such as by capillary action. Upon cooling and solidification, the brazing material may secure the cutting element 416 to the cutting element pocket 417. In some embodiments, the brazing temperature may be in a range having an upper value, a lower value, or upper and lower values including any of 800° F., 1000° F., 1200° F., 1400° F., 1600° F., 1800° F., 2000° F., or any value therebetween. For example, the brazing temperature may be greater than 800° F. In another example, the brazing temperature may be less than 2000° F. In yet other examples, the brazing temperature may be between 800° F. and 2000° F. In some embodiments, it may be critical that the brazing temperature be between 1300° F. and 1600° F. to facilitate bonding of the cutting element 416 to the cutting element pocket 417 by the brazing material without damaging the cutting element 416, the cutting element pocket 417, and/or the blade 414. In this way, the induction heater may be employed to heat the cutting element 416 and/or the cutting element pocket 417 to a brazing temperature.

In some embodiments, the brazing system 420 may maintain the temperature of the cutting element 416 and/or the blade 414 below a critical temperature. The critical temperature may be the temperature above which the blade 414 and/or the cutting element 416 may become damaged. In some embodiments, the critical temperature may be in a range having an upper value, a lower value, or upper and lower values including any of 1300° F., 1400° F., 1500° F., 1600° F., 1700° F., 1800° F., 1900° F., 2000° F., or any value therebetween. For example, the critical value may be greater than 1300° F. In another example, the critical temperature may be less than 2000° F. In yet other examples, the critical temperature may be between 1300° F. and 2000° F. In some embodiments, it may be critical that the critical temperature be between 1300° F. and 1600° F. to reduce or prevent damage to the ultrahard portion 432, the cutting element 416, the cutting element pocket 417, and/or the blade 414 during the brazing process.

In some embodiments, the cutting element pocket 417 and/or the cutting element 416 may be heated to a preliminary temperature that is less than the brazing temperature. The induction heater 424, a pre-heating system, or a combination thereof may heat the cutting pocket 417 and/or the cutting element 416 to the preliminary temperature. In some embodiments, the preliminary temperature may be more or less than 1000° F. In some embodiments, the preliminary temperature may be in a range having an upper value, a lower value, or upper and lower values including any of 500° F., 600° F., 700° F., 800° F., 900° F., 1000° F., 1100° F., 1200° F., 1300° F., or any value therebetween. For example, the preliminary temperature may be more than 500° F. In another example, the preliminary temperature may be less than 1300° F. In yet another example, the preliminary temperature may be between 500° F. and 1300° F. In some embodiments, it may be critical that the preliminary temperature be between 800° F. and 1000° F. to facilitate adequate brazing of the cutting element 416 to the cutting element pocket 417 with the brazing system 420 as discussed herein.

In some embodiments, the induction heater 424 may heat the cutting element pocket 417 and/or the cutting element 416 to the brazing temperature in a heat-up period. The heat-up period may be for each cutting element pocket 417 or a subset of the cutting element pockets 417 of the blade 414. In some embodiments, the heat-up period may be more or less than 30 seconds. In some embodiments, the heat-up period may be in a range having an upper value, a lower value, or upper and lower values including any of 10 seconds, 30 seconds, 60 seconds, 90 seconds, 120 seconds, 150 seconds, 180 seconds or any value therebetween. For example, the heat-up period may be greater than 10 seconds. In another example, the heat-up period may be less than 180 seconds. In yet other examples, the heat-up period may be any value in the range between 10 seconds and 180 seconds. In some embodiments, it may be critical that the heat-up period be between 20 seconds and 40 seconds to increase the speed and/or reduce the cost of brazing the blade 414.

In some embodiments, the induction heater 424 may maintain the brazing temperature for a brazing period. The brazing period may be for each cutting element pocket 417 or a subset of the cutting element pockets 417 of the blade. In some embodiments, the brazing period may be more or less than 30 seconds. In some embodiments, the brazing period may be in a range having an upper value, a lower value, or upper and lower values including any of 10 seconds, 20 seconds, 30 seconds, 40 seconds, 50 seconds, 60 seconds, or any value therebetween. For example, the brazing period may be greater than 10 seconds. In another example, the brazing period may be less than 60 seconds. In yet other examples, the brazing period may be any value in the range between 10 seconds and 60 seconds. In some embodiments, it may be critical that the brazing period be between 20 and 40 seconds to generate a quality braze.

In some embodiments, the brazing zone of the induction heater 424 may be localized to the cutting element pocket 417 such that an adjacent cutting element pocket may be located outside of the brazing zone. A temperature gradient may exist between the temperature of the cutting element pocket 417 and an adjacent cutting element pocket 417-1. In some embodiments, the temperature gradient may be in a range having an upper value, a lower value, or upper and lower values of any of 100° F., 200° F., 300° F., 400° F., 500° F., 600° F., 700° F., 800° F., 900° F., 1000° F., or any value therebetween. For example, the temperature gradient may be a difference of more than 100° F. In another example, the temperature gradient may be a difference of less than 1000° F. In yet another example, the temperature gradient may be a difference between 100° F. and 1000° F. In some embodiments, it may be critical that the temperature gradient be a difference between 500 OF and 1000° F. for the heating effect of the induction heater to be localized to the cutting element pocket 417 and/or for the adjacent cutting element pocket 417-1 to be preheated using the brazing system described herein, thereby reducing the heat up period of the adjacent cutting element pocket 417-1.

FIG. 4-2 is a cross-sectional view of the brazing system 420 of FIG. 4-1. As may be seen, the brazing system 420 may include a brazing material 413. The brazing material 413 may be located at a base of the cutting element pocket 417 between the cutting element 416 and the base of the cutting element pocket 417. In some embodiments, the brazing material 413 may be inserted into the cutting element pocket 417 before the cutting element 416 is inserted into the cutting element pocket 417. In some embodiments, the brazing material may include one or more filler metals such as copper, nickel, silver, aluminum, gold, manganese, or any other metal and/or rare-earth elements suitable for bonding the cutting element 416 to the cutting element pocket 417. In some embodiments, the brazing material 413 may be in a solid form such as a brazing disk, foil, ring, wire, slug, washer, or any other suitable solid form of the brazing material 413. In this way, the brazing material 413 may be placed or inserted into the cutting element pocket 417 in a solid form before inserting the cutting element 416 into the cutting element pocket 417. In some embodiments, the brazing material 413 may be in a non-solid form such as atomized into a powder or particulate, a paste, or a liquid. In this way, the cutting element pocket 417 may be at least partially filled with the brazing material 413 before inserting the cutting element 416. In some embodiments, the brazing material 413 may be applied to (i.e., painted or coated onto) the cutting element pocket 417 and/or the cutting element 416 before the cutting element 416 is inserted into the cutting element pocket 417. In some embodiments, the brazing material 413 may be applied to the joint between the cutting element 416 and the cutting element pocket 417 after the cutting element 416 is inserted into the cutting element pocket 417. For example, the brazing material 413 may be applied to the joint after the cutting element pocket 417 and/or the cutting element 416 is heated, such as to the brazing temperature.

During brazing, oxides or impurities may form on one or more surfaces of the cutting element 416 and/or the cutting element pocket 417. This may weaken the bond created between the cutting element 416 and the cutting element pocket 417. Heating of the cutting element 416 and/or the cutting element pocket 417 may increase or accelerate the forming of oxides. For this purpose, conventional methods typically introduce a flux material to the mating surfaces of the cutting element 416 and/or cutting element pocket 417 to shield these surfaces from the formation of oxides. In some embodiments, the brazing material 413 may include a flux material. In some embodiments, the brazing material 413 may not contain a flux material such that the flux material, if used, may be separately used or applied apart from the brazing material 413.

Conventionally, brazing of an entire blade 414 or bit may consume several hours. A long-lasting flux material (sometimes refer to high-temperature flux material), such as a “brown flux,” may be used to provide long-lasting shielding from oxide formation during conventional brazing methods. In some embodiments, a long-lasting flux material may be a high-temperature flux material. As discussed herein, the present brazing process may be performed during a brazing period which may be shorter than the brazing durations of traditional brazing methods, such as less than 60 seconds. In some embodiments, the brazing system 420 as discussed herein may use a flux material that is not long-lasting. In some embodiments, the flux material may be a medium-high-temperature flux material, a “white flux,” or a water-based flux. In some embodiments, brazing according to the brazing system 420 as discussed herein may be performed without a flux material. In some embodiments, the brazing system 420 may include a vacuum system such that one or more of the functions of the brazing system 420 may be performed in a vacuum or under substantially zero atmospheric pressure.

Long-lasting flux materials may leave residual flux material in the joint when brazing is complete. This residual material may weaken the bond between the cutting element 416 and the cutting element pocket 417. Shorter-duration flux material may leave less residue or no residue. With a long-lasting flux material, some of the residual material may be removed from the brazed connection by spinning or rotating an angular orientation of the cutting element 416 within the cutting element pocket 417 after the brazing material 413 has melted. This may remove the residual flux material from the joint before the brazing material cools and hardens, or before brazing is complete. In some embodiments, the brazing system 420 as described herein may braze the cutting element 416 to the cutting element pocket 417 without spinning or rotating an angular orientation of the cutting element 416 within the cutting element pocket 417. In other words, an angular orientation of the cutting element 416 may be maintained or unchanged throughout the brazing process. This may be because the short-duration flux may leave little to no residual material in the joint. This may help to strengthen the braze and increase the contact of the brazing material 413 with the cutting element 416 and the body of the blade 414.

In some embodiments, the cutting element 416 may be pushed into, or seated in the cutting element pocket 417 after the brazing material 413 has melted but before it has hardened. As discussed herein, seating of the cutting element 416 in the cutting element pocket 417 may be performed without spinning or rotating an angular orientation of the cutting element 416 in the cutting element pocket 417. In other words, the cutting element 416 may be seated, or pushed into, the cutting element pocket 417 while maintaining an angular orientation of the cutting element 416. This may help to simplify the brazing process while maintaining a strong bonding of the cutting element 416 to the cutting element pocket 417. In some embodiments, the cutting element 416 may be seated manually by an operator. In some embodiments, the brazing system 420 may seat the cutting element 416 autonomously such as with a robotic arm.

A push out load is appreciated as an amount of force required to press the cutting element 416 out of the cutting element pocket 417. This may correspond to a strength of the braze or the strength of the connection created between the cutting element 416 and the cutting element pocket 417. In some embodiments, the braze performed by the brazing system 420 may be a full strength braze. This may correspond to a strength or a push out load comparable to that achieved through conventional methods, in accordance with the brazing system described herein.

FIGS. 4-3 and 4-4 are a front view of the brazing system 420 of FIG. 4-1. As discussed herein, the induction heater 424 may be positioned and/or movable relative to the blade 414. The induction heater 424 may be movable along a heating path 428. In some embodiments, the heating path 428 may correspond to a geometry of a blade of a bit, such as the bit 210 discussed herein in connection with FIG. 2. The heating path 428 and the brazing system 420 may be adaptable to the geometry of any downhole tool including cutting elements 416 brazed to a blade 414. In some embodiments, the heating path 428 may be a predetermined heating path 428. For example, the heating path 428 may be determined by an operator input to the brazing system 420. In some embodiments, an operator may manually determine the heating path 428 and may program the brazing system to follow the determined heating path 428. In another example, the heating path may be determined autonomously by the brazing system 420. In some embodiments, the brazing system 420 may scan the geometry of the downhole tool, including the particular geometry of the blade 414 and a computing device may determine the heating path 428 based on the geometry of the downhole tool.

In some embodiments, the heating path 428 may have a first end 429 and a second end 430. The heating path 428 may follow a succession of adjacent cutting element pockets 417. In this way, discrete locations along the heating path 428 may correspond to the induction heater 424 being positioned adjacent to, in close proximity to, or relative to one or more cutting element pockets 417. The heating path may define an offset distance 427 between the induction heater 424 and the blade 414. For example, the offset distance 427 may be a distance between the induction coil 425 and the first side 418 of the blade. In this way, the induction coil 425 may be offset, or may not directly contact the blade 414.

In some embodiments the offset distance 427 may be a constant distance throughout an entirety of the heating path 428. For example, as shown in FIGS. 4-3 and 4-4, the heating path 428 may be substantially parallel to the first side 418 of the blade 414, and the induction coil 425 may be positioned a constant distance from the blade 414 throughout an entirety of the movement of the induction heater 424 along the heating path 428. In some embodiments, the offset distance 427 may not be constant. For example, the brazing system 420 may move the induction coil 425 closer to and/or further from the blade 414 at one or more times throughout a movement of the induction heater 424 along the heating path 428. In some embodiments, the offset distance 427 may be changed to accommodate a geometry of the bit. In some embodiments, the offset distance 427 may be changed to control the heating effect of the induction heater 424, as will be discussed herein.

As discussed herein, the induction heater 424 may move along the heating path 428. In some embodiments, the induction heater may move at a constant velocity along the heating path 428. For example, the induction heater 424 may preheat one or more portions of the blade 414 by traveling at a constant velocity along the heating path. In some embodiments, the induction heater 424 may change velocities one or more times as it moves along the heating path 428. For example, the induction heater 424 may speed up as it departs from one cutting element pocket 417 and may slow at is approaches another cutting element pocket 417. In this way, the movement of the induction heater 424 along the heating path may be dynamic.

The heating path 428 is shown in FIGS. 4-3 and 4-4 as being a straight line. It should be understood, however, that the heating path 428 may be non-linear, and one or more portions of the heating path 428 may follow a path of a non-linear shape. For example, in some embodiments, the blade 414 may include one or more portions that are substantially non-linear, such as the blade 214 described in FIG. 2. Accordingly, one or more portions of the heating path 428 may similarly define a non-linear path in order to accommodate the non-linear geometries of the blade 414. In another example, the heating path 428 may follow one or more shapes and/or patterns, such as circular, elliptical, figure-8, rectangular, any other shape and/or pattern, and combinations thereof. The pattern and/or shape of the heating path 428 may help to control the heating effect of the induction heater and/or apply heat in desired locations. In this way, the heating path may follow any number of linear and/or non-linear paths to apply the heating effect of the induction heater 424 to any number of bit geometries.

As discussed herein, the induction heater 424 may generate a magnetic field resulting in a heating effect being applied to the blade 414. The heating effect may be localized to a brazing zone 415. In some embodiments, one or more parameters of the brazing system may be adjusted to control the brazing zone. For example, moving the induction heater 424 along the heating path 428 may accordingly move the brazing zone along the blade 414 with respect to the heating path 428. In another example, moving the induction heater 424 in a patterned movement along the heating path 428 may target the brazing zone at various distinct locations of the blade 414. In another example, changing the offset distance 427 may affect the application of the brazing zone 415 to the blade 414. In yet another example, adjusting an energy input (e.g., frequency, amplitude) to the induction coil may affect the application of the brazing zone 415 to the blade 414. The brazing zone 415 may be adjusted changed in various ways as a result of adjusting one or more of the parameters just mentioned. For example, adjusting one or more parameters may change the depth at which the brazing zone 415 penetrates into the blade 414. In another example, adjusting one or more parameters may change a width or a cross sectional area which the brazing zone 415 encompasses. In a further example, adjusting one or more parameters may change the intensity of the generated magnetic field, which may result in the brazing zone 415 producing a more rapid increase in temperature of the blade 414. In this way, the brazing zone may be tailored to produce a desired heating effect as described herein.

In some embodiments, the induction heater 424 may travel at least a portion of the heating path 428 while no electrical energy input is being supplied to induction heater 424, or without generating a magnetic field. In other words, the induction heater 424 may travel at least a portion of the path without applying the heating effect of the induction heater 424 to the blade 414. The induction heater 424 may travel at least a portion of the heating path while an electrical energy input is being supplied to the induction heater 424, or while generating a magnetic field. In other words, the induction heater 424 may travel at least a portion of the heating path while applying the heating effect of the induction heater 424 to the blade 414. Electrical energy may be directed through the induction coil 425 in a phased manner while the induction heater 424 moves along the heating path 428 such that the induction heater 424 may precisely control the location and duration of the induced current in the blade 414 for heating the blade 414. In this way, the induction heater 424 may move along the heating path 428 and be positioned relative to the blade 414, while the heating effect of the induction heater 424 may be selectively applied to the blade 414.

In accordance with at least one embodiment of the present disclosure, the induction heater 424 may be initially positioned at the first end 429. The induction heater 424 may travel along the heating path 428 toward the second end 430. The induction heater 424 may slow or stop at a first location 423-1 along the heating path 428. The first location 423-1 may correspond to the induction heater 424 being positioned adjacent or relative to a first cutting element pocket 417-1 located along the heating path 428. This first location 423-1 may also correspond to the brazing zone 415 being directed at the first cutting element pocket 417-1. While the induction heater 424 is located at the first location 423-1, as discussed herein, the induction heater 424 may heat the first cutting element pocket 417-1, a first cutting element 416-1, and/or a brazing material to bond the first cutting element 416-1 to the first cutting element pocket 417-1.

After brazing of the first cutting element 416-1 is complete, the induction heater may then resume travel along the heating path 428, such as toward the second end 430. In some embodiments, the induction heater 424 resuming travel along the heating path 428 may be based on an operator input such as an operator inputting an indication that brazing of the first cutting element 416-1 is complete. For example, an operator may input an indication that the first cutting element 416-1, the first cutting element pocket 417-1, and/or the brazing material have reached the brazing temperature and the first cutting element 416-1 is seated in the first cutting element pocket 417-1. In another example, an operator may input an indication that the brazing period has elapsed. In some embodiments, the operator input may be based on indication received from an indicator coupled to the brazing system. For example, the operator may monitor one or more conditions of the brazing process with the indicator, and the operator input one or more inputs to the brazing system to advance the brazing process based on one or more of the observed conditions.

In some embodiments, the induction heater 424 resuming travel along the heating path 428 may be automated by the brazing system 420. For example, the brazing system 420 may determine that the first cutting element pocket 417-1, the first cutting element 416-1 and/or the brazing material have reached the brazing temperature and the first cutting element 416-1 is seated in the first cutting element pocket 417-1. In another example, the brazing system 420 may determine that the brazing period has elapsed. In this way, the induction heater 424 may bond the first cutting element 416-1 to the first cutting element pocket 417-1, and may be advanced along the heating path 428 once brazing of the first cutting element 416-1 has been achieved.

In the embodiment shown in FIG. 4-4, the induction heater 424 may advance along the heating path 428 from the first location 423-1 and stop at a second location 423-2. The second location 423-2 may be located further along the heating path 428 than the first location 423-1. The second location 423-2 may correspond to the induction heater 424 being positioned adjacent to a second cutting element pocket 417-2 located along the heating path 428. The second location 423-2 may also correspond to the brazing zone 415 being directed at the second cutting element pocket 417-2. As discussed herein, a second cutting element 416-2 may be brazed to the second cutting element pocket 417-2 corresponding to the second location 423-2, and the induction heater 424 may be advanced from the second location 423-2 along the heating path 428. The induction heater may proceed in this manner for any number of cutting element pockets 417 that may be located along the heating path 428. In some embodiments, the induction heater 424 may stop for a longer duration at some of the locations 423. For example, brazing of the first cutting element 416-1 to the first cutting element pocket 417-2 may correspond to the blade 414 being “cold” or not being preheated. Accordingly, it may take longer for the induction heater 424 to heat the various elements to the brazing temperature. When the induction heater proceeds to later cutting elements pockets 417 in a series of cutting element pockets 417, the later cutting element pockets 417 may be warmer, or somewhat preheated due to heat conduction through the blade 414 from the brazing of previous cutting element pockets 417. Accordingly, the induction heater may stop for a shorter duration at later cutting element pockets 417 as needed to braze later cutting elements 416 to the cutting element pockets 417. In this way, the induction heater 424 may braze one or more cutting elements 416 to one or more cutting element pockets 417 located along the heating path 428 by moving along the heating path 428.

As discussed herein, in some embodiments, the induction heater 424 may be used to heat one or more cutting element pockets 417, cutting elements 416 and/or the brazing material 413 to a preliminary temperature, such as to 800° F. For example, the induction heater 424 may make a preliminary pass of the heating path 428 to heat one or more cutting element pockets 417, cutting elements 416 and/or the brazing material 413 to the preliminary temperature before heating one or more of the cutting element pockets 417, cutting elements 416 and/or the brazing material 413 to the brazing temperature, or before brazing the cutting element 416 to the cutting element pocket 417. In some embodiments, the preliminary pass may follow a path different from that of the heating path 428. In this way, the blade 414, and/or one or more of the cutting element pockets 417, the cutting element 416, and/or the brazing material 413 may be preheated or heated to a preliminary temperature less than the brazing temperature prior to brazing. In some embodiments, this preheating may help to reduce the brazing period. In some embodiments, this may help to reduce the amount of oxides or impurities that may form on one or more surfaces of the cutting element 416 and/or the cutting element pocket 417 during the brazing process.

In some embodiments, the induction heater 424 may make the preliminary pass at a constant velocity from the first end 429 to the second end 430 to generally pre-heat the blade 414 along the cutting element pocket 417 to the preliminary temperature. The brazing system 420 may then proceed to heat and/or braze individual cutting element pockets and/or cutting elements as discussed herein. In some embodiments, the induction heater 424 may make the preliminary pass of the heating path 428 and may make one or more stops along the heating path 428 to individually pre-heat the cutting element pockets 417 along the heating path 428 to the preliminary temperature. The brazing system 420 may then proceed to heat and/or braze individual cutting element pockets and/or cutting elements as discussed herein. In some embodiments, the induction heater 424 may make multiple preliminary passes along the heating path 428 to heat the cutting element pockets 417 to the preliminary temperature. In some embodiments, the induction heater 424 may heat one or more cutting elements 416 and/or cutting element pockets 417 without making a preliminary pass of the heating path 428 and the temperature gradient as discussed herein may pre-heat the adjacent cutting element pocket.

In some embodiments, the brazing system 420 may be fully autonomous. For example, the brazing system 420 may perform all of the functionalities discussed herein without the aid or input of an operator such as: initially positioning the blade 414 relative to a robotic arm, inserting the cutting element 416 and/or brazing material 413 into the cutting element pocket 417, determining the heating path 428, applying and/or controlling an energy input to the induction heater 424, moving and/or advancing the induction heater 424 along the heating path 428, seating the cutting element 416, any other functionality, and combinations thereof. In some embodiments, the brazing system 420 may be at least partially operated by an operator. For example, the brazing system 420 may be semi-autonomous, and at least a portion of the functionalities discussed herein of the brazing system 420 may be performed by an operator, or with the aid or input of an operator. In some embodiments, an operator may perform various tasks as part of an initial setup procedure. For example, an operator may initially insert or position the blade 414 relative to a robotic arm of the brazing system 420 as discussed herein. In some examples, an operator may insert the cutting element 416, the brazing material 413, and/or a flux material into the cutting element pocket 417. As discussed herein, in some examples, an operator may determine the heating path 428 and may input the heating path 428 or program the brazing system 420 to follow the heating path 428.

In some embodiments, an operator may perform various tasks during, or as part of the brazing process. For example, an operator may manually control the movements of the induction heater 424 such as by controlling a robotic arm as discussed herein. In some examples, an operator may apply and/or control an energy input to the induction heater 424. In some examples, the brazing system 420 may move the induction heater 424 along the heating path 428 subject to an operator input, such as an operator determining when to advance the induction heater 424 along the heating path to another cutting element pocket 417, when to apply, adjust, or stop an energy input to the induction heater 424, when to stop the induction heater 424 at a location along the heating path 428, and combinations thereof. In some examples, an operator may manually push in, or seat the cutting element 416 in the cutting element pocket 417 as discussed herein. In this way, the brazing system 420 may be semi-autonomous which may simplify the brazing process and eliminate the need to automate portions of the brazing process that may be cumbersome or difficult for a fully autonomous system to complete.

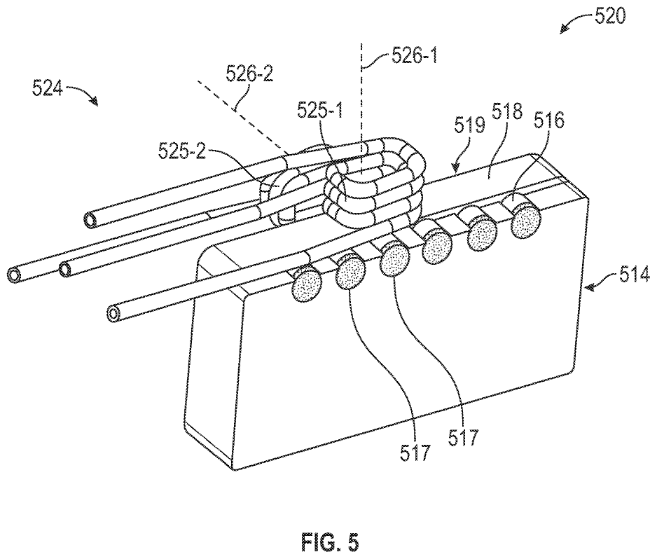

FIG. 5 is a perspective view of a brazing system 520, according to at least one embodiment of the present disclosure. As described herein, the brazing system may include a blade 514 with one or more cutting elements 516 and one or more cutting element pockets 517. The blade 514 may have a first side 518 and a second side 519. The brazing system 520 may include an induction heater 524 positionable relative to the blade 514. In some embodiments, the induction heater 524 may include a plurality of induction coils. For example, the induction heater may include a first induction coil 525-1 and a second induction coil 525-2. In the embodiment shown in FIG. 5, a first coil axis 526-1 through the center of the first induction coil 525-1 and a second coil axis 526-2 through the center of the second induction coil 525-2 may define an angle that is substantially 90°. In other words, the first induction coil 525-1 and the second induction coil 525-2 may be substantially perpendicular to each other. In some embodiments, the first coil axis 526-1 and the second coil axis 526-2 may define an angle that is not 90°. For example, the angle between the first coil axis 526-1 and the second coil axis 526-2 may be substantially 180°, which may correspond to the first coil axis 526-1 and the second coil axis 526-2 being coincident. An angle between the first coil axis 526-1 and the second coil axis 526-2 may be any other angle, such as any angle between 0° and 180°. In some embodiments, no angle may be defined between the first coil axis 526-1 and the second coil axis 526-2. For example, the first coil axis 526-1 and the second coil axis 526-2 may be substantially parallel, which may correspond to the first induction coil 525-1 and the second induction coil 525-2 being substantially side by side. In this way, the first induction coil 525-1 and the second induction coil 525-2 may be oriented with respect to each other.

In some embodiments, the first induction coil 525-1 and the second induction coil 525-2 may be electrically coupled such that they are both part of the same circuit. For example, an energy input to the first induction coil 525-1 may be the same energy input as an energy input to the second induction coil 525-2. In this way, the first induction coil 525-1 and the second induction coil 525-2 may be controlled together. In some embodiments, the first induction coil 525-1 and the second induction coil 525-2 may not be part of the same circuit. For example, an energy input to the first induction coil 525-1 may be a different energy input than an energy input to the second induction coil 525-2. In this way, the first induction coil 525-1 and the second induction coil 525-2 may be controlled separately and independently of one another. In some embodiments, the first induction coil 525-1 and the second induction coil 525-2 may have different energy outputs, or may create magnetic fields of different intensity. Separately controlled induction coils may enable the generation of differential magnetic fields with different induced currents for resistive heating of portions of the blade 514. For example, the second induction coil 525-2 may generate a broader and/or more intense second magnetic field to generate a second brazing zone that is larger and/or deeper within the blade 514 than the first magnetic field generated by the first induction coil 525-1. This may help to create a desired intensity and/or heating zone with respect to the cutting element 516 and/or the cutting element pocket 517. In this way, an energy output of the induction heater 524 may be tailored for a particular application.

In some embodiments, the first induction coil 525-1 and the second induction coil 525-2 may be physically coupled together. This may correspond to the first induction coil 525-1 and the second induction coil 525-2 being movable together. For example, the first induction coil 525-1 and the second induction coil 525-2 may each be connected to the working end of a robotic arm as discussed herein. The robotic arm may move and/or orient the first induction coil 525-1 and the second induction coil 525-2 together as a single integral unit. In some embodiments, the first induction coil 525-1 and the second induction coil 525-2 may not be physically coupled together. This may correspond to the first induction coil 525-1 and the second induction coil 525-2 each being separately movable. For example, the first induction coil 525-1 and the second induction coil 525-2 may each be connected to the working end of separate robotic arms as discussed herein. The robotic arms may move and/or orient each of the first induction coil 525-1 and the second induction coil 525-2 separately. In this way, the first induction coil 525-1 and the second induction coil 525-2 may be movable and may be oriented with respect to the blade 514.

As described herein, the first induction coil 525-1 and the second induction coil 525-2 may each generate a separate magnetic field. In some embodiments, the first induction coil 525-1 may generate a first magnetic field and the second induction coil 525-2 may generate a second magnetic field independent of the first magnetic field. In the embodiment shown in FIG. 5, the first induction coil 525-1 and the second induction coil 525-2 may be positioned adjacent to, or in close proximity to each other. The adjacent orientation may cause the first magnetic field and the second magnetic field to interact with each other. In this way, the first induction coil 525-1 and the second induction coil 525-2 may work together to generate a single magnetic field. As shown in FIG. 5, the first induction coil 525-1 and the second induction coil 525-2 may be oriented to generate a magnetic field to target or be oriented at a brazing site and generate a brazing zone via induced electric current. In this way, the first induction coil 525-1 and the second induction coil 525-2 may cooperate to heat a localized portion of the blade 514. For example, the heating effect of the electric current induced by the magnetic field may be focused substantially on a portion of the first side 518 and of the second side 519 that corresponds to the cutting element pocket 517. In this way, the heating effect of the electric current induced by the magnetic field may be focused on and localized to the cutting element pocket 517. In some embodiments, the electric current induced by the magnetic field may cause at least a portion of the cutting element pocket 517 to increase in temperature. The cutting element 516 may increase in temperature either directly due to the electric current induced by the magnetic field, or indirectly due to thermal conduction from the cutting element pocket 517 that itself is heated by the electric current induced by the magnetic field. In this way, the induction heater may heat the cutting element pocket 517 and/or cutting element 516 through generation of the magnetic field.

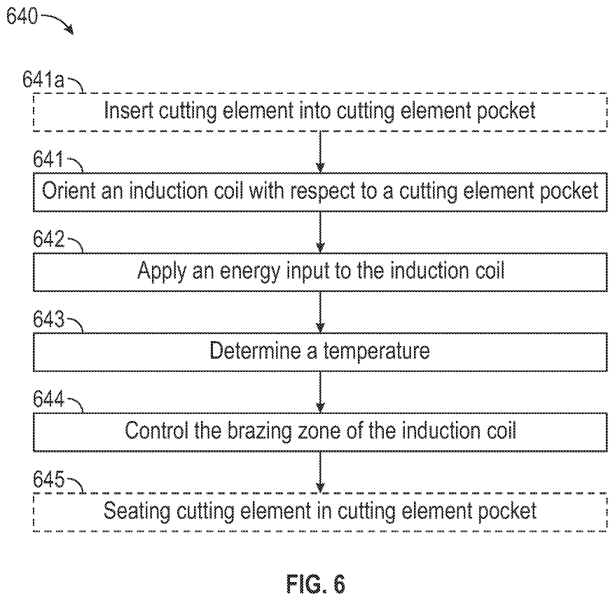

FIG. 6 illustrates a flowchart of a method 640 or a series of acts for using the brazing system as discussed herein, according to at least one embodiment of the present disclosure. While FIG. 6 illustrates acts according to one embodiment, alternative embodiments may omit, add to, reorder, and/or modify any of the acts shown in FIG. 6.

The method 640 may include orienting an induction coil with respect to a cutting element pocket at 641. For example, the brazing system may orient a robotic arm, and the robotic arm may include the induction coil on a working end thereof. In some embodiments, the brazing system may orient the robotic arm by moving the induction coil along a heating path. In some embodiments, the heating path may be determined by the brazing system. For example, the brazing system may scan the geometry of a tool body and determine the heating path based on the geometry of the tool body. In some embodiments, the heating path may be determined by an operator of the brazing system. For example, the operator may manually determine the heating path based on the geometry of the tool body and may input the heating path into the brazing system. In some embodiments, the heating path may be offset by an offset distance corresponding to the induction heater being positioned such that it does not contact the tool body. In this way, the brazing system may orient the induction heater with respect to the cutting element pocket at 641 in order to perform the functionalities discussed herein.

In at least one embodiment of the present disclosure, the method 640 may include inserting a cutting element into the cutting element pocket. At 641a. In some embodiments, the cutting element may include an ultrahard portion. As discussed herein, the brazing system may braze the cutting element to the cutting element pocket. In some embodiments, the brazing system may be used to determine a temperature of one or more components of the brazing system at 643. For example, the brazing system may determine a temperature of a cutting element, a cutting element pocket, a brazing material, an ultrahard portion, or any other component as described herein. Controlling the induction heater as discussed herein may be at least partly based on the determined temperature. For example, the brazing system may maintain the temperature (i.e., an ultrahard portion temperature) below the critical temperature. In some embodiments, a brazing material may be applied to the cutting element pocket. For example, the brazing material may be applied to the cutting element pocket before inserting the cutting element into the cutting element pocket at 641a and/or before applying an energy input to the induction coil at 642.

The brazing system may apply an energy input to the induction coil at 642. In some embodiments, applying the energy input to the induction coil may heat the cutting element pocket to a brazing temperature. In some embodiments, applying the energy input to the induction coil may heat the cutting element pocket to a brazing temperature with a heat up period of 60 seconds or less. The brazing system may melt the brazing material while at the brazing temperature. In some embodiments, the system may braze the cutting element to the blade without using a flux material. In some embodiments, the brazing system may apply the heating effect of the induction heater in a focused or localized manner. For example, the heating effect of the induction heater may be localized to a brazing zone as discussed herein.

The method may include at 643 determining a temperature of one or more components of the brazing system at 643. For example, the brazing system may determine a temperature of a cutting element, a cutting element pocket, a brazing material, an ultrahard portion, or any other component as described herein. For example, the brazing system may determine the pocket temperature at a portion of the metal matrix or steel surrounding the cutting element pocket. In another example, the brazing system may determine the temperature at the substrate of the cutting element. The brazing system may determine the temperature of the one or more components of the brazing system using an infrared camera directed at the brazing system. As discussed above, the one or more thermal sensors may be used to simultaneously or sequentially determine the temperatures of multiple components of the brazing system.

The method 640 may include controlling a brazing zone of the induction heater at 644. In some embodiments the brazing system may control the brazing zone by adjusting one or more parameters of the brazing system. For example, the brazing zone may be controlled by controlling an energy input to the induction coil, moving the induction coil along the heating path, adjusting an offset distance of the heating path, adjusting any other parameter of the brazing system, and combinations thereof. In accordance with at least one embodiment of the present disclosure, the brazing system may control the brazing zone of the induction heater to maintain the temperature (i.e., the temperature of 643) at the brazing temperature for a brazing period. The brazing system may control the brazing zone based on the temperature determined at 643. For example, if the temperature is determined to be lower than the brazing temperature, the brazing system may maintain and/or increase an energy input to the induction coil. In another example, if the temperature is determined to be at the brazing temperature, the brazing system may maintain and/or decrease the energy input to the induction coil. In yet other examples, if the temperature is determined to be greater than the brazing temperature, the brazing system may decrease and/or stop an energy input to the induction coil. In some embodiments, controlling the brazing zone of the induction heater may include controlling an electrical energy input to the induction coil, which in turn controls the magnetic field from the induction coil and the electric current induced in the cutting element pocket and/or cutting element substrate. The brazing zone may be controlled at 644 to maintain a first temperature (e.g., brazing temperature) in one or more locations without exceeding a second temperature (e.g., critical temperature) in another location, such as an ultrahard layer or webbing between cutter pockets in or near the brazing zone.

In some embodiments, the method 640 may include seating (e.g., pushing) the cutting element into the cutting element pocket at 645. For example, a robotic arm of the brazing system may seat the cutting element into the cutting element pocket after the brazing material has melted or after the brazing period. In another example, an operator may seat the cutting element into the cutting element pocket after the brazing material has melted or after the brazing period. In some embodiments, the cutting element may be seated into the cutting element pocket without spinning the cutting element. For example, an angular orientation of the cutting element with respect to the cutting element pocket may be maintained while the cutting element is pushed into the cutting element pocket.

In some embodiments, the cutting element pocket may be a first cutting element pocket, the temperature may be a first pocket temperature, and a second cutting element pocket may be located along the heating path. As discussed herein, the method 640 may further include orienting the induction coil with respect to the second cutting element pocket; applying an energy input to the induction coil to heat the second cutting element pocket to the brazing temperature; determining a second temperature of the second component; and/or controlling the brazing one of the induction heater to maintain the second temperature at the brazing temperature for the brazing period. The brazing system may be used to control the brazing zone based on the determined second temperature. In some embodiments, the brazing system may control the brazing zone of the induction heater to heat one or more components to a preliminary temperature less than the brazing temperature. For example, the brazing system may heat a first cutting element pocket and a second cutting element pocket to the preliminary temperature before heating the first cutting element pocket to the brazing temperature.

In some embodiments, the induction coil is a first induction coil, and the brazing system may orient the first induction coil adjacent to a first side of the cutting element pocket. The brazing system may orient a second induction coil adjacent to a second side of the cutting element pocket. In some embodiments, the brazing system may apply an energy input to the first induction coil and the second induction coil to heat the cutting element pocket to the brazing temperature. As discussed herein, the brazing system may control the energy input to the first induction coil and the second induction coil to maintain the temperature of a cutting element pocket at the brazing temperature for the brazing period. For example, the brazing system may control the energy input to the first induction coil and the second induction coil based on a determined temperature of the cutting element pocket or another component of the brazing system.

As discussed herein, the method 640 may include inserting a cutting element into the cutting element pocket at 641a, and the cutting element may include an ultrahard portion on a distal end of the cutting element. In some embodiments, the distal end may be an end of the cutting element oriented adjacent to a third side (i.e., front) of the cutting element pocket opposite the first side (i.e., rear). In some embodiments, the brazing system may apply an energy input to the first induction coil and the second induction coil to heat the cutting element pocket from the first side (i.e., rear) and the second side (i.e., top). For example, the magnetic field generated by the first induction coil and the second induction coil may generate a heating effect that originates within a blade containing the cutting element pocket. The heating effect may be focused on and/or localized to the first side and the second side such that the distal end and/or the ultrahard portion of the cutting element does not receive the heating effect, or receives the heating effect to a lesser degree. In this way, the brazing system may produce a more precise and localized heating effect than conventional methods (e.g., torch heating) in order to more effectively braze a cutting element to a cutting element pocket through one or more acts of the method 640.

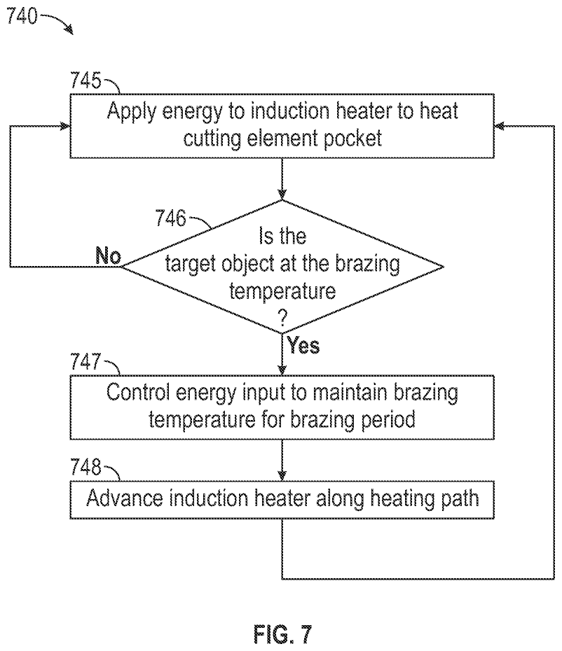

FIG. 7 illustrates a flowchart of a method 740 or a series of acts for using the brazing system as discussed herein, according to at least one embodiment of the present disclosure. While FIG. 7 illustrates acts according to one embodiment, alternative embodiments may omit, add to, reorder, and/or modify any of the acts shown in FIG. 7.

The method 740 may include applying an energy input to an induction heater to heat a cutting element pocket at 745. As discussed herein, the brazing system may employ a control loop for controlling the energy input and heating effect of the induction heater on a target object (i.e., a bit) located within the magnetic field generated by the induction heater. For example, the method 740 may include determining whether the target object is at the brazing temperature at 746. The target object may be, for example, a cutting element pocket, a cutting element, and/or a brazing material as discussed herein, and the brazing system may determine whether one or more of these objects is at the brazing temperature at 746. If it is determined that the target object is not at the brazing temperature, the method 740 may loop back to 745. This looping between applying energy to the induction heater and determining whether the target object is at the brazing temperature may continue until it is determined that the target object is at the brazing temperature. In this way, the brazing system may include a control loop as discussed herein to control the heating effect of the induction coil to heat a target object to the brazing temperature.

When it is determined that the target object (e.g., the cutting element pocket, the cutting element, and/or the brazing material) is at the brazing temperature, the brazing system may control the energy input to the induction heater to maintain the target object at the brazing temperature for the brazing period at 747. As discussed herein, the brazing period may be between 10 and 60 seconds. In some embodiments, the brazing period may be 30 seconds. After the brazing period, the brazing system may advance the induction heater along the heating path at 748. For example, the brazing system may advance the induction heater along the heating path from one target object to another target object along the heating path (e.g., from one cutting element pocket to another cutting element pocket). In some embodiments, the brazing system may proceed back to applying energy to the induction heater to heat another target object at 745. Put another way, the brazing system may begin the method 740 again with respect to another target object located along the heating path. In this way, the brazing system may be used to implement one or more acts of the method 740 in conjunction with any number of target objects (e.g., to braze multiple cutting elements to a succession of cutting element pockets).

The embodiments of the brazing system have been primarily described with reference to wellbore drilling operations; the brazing system described herein may be used in applications other than the drilling of a wellbore. In other embodiments, the brazing system according to the present disclosure may be used outside a wellbore or other downhole environment used for the exploration or production of natural resources. For instance, the brazing system of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of bonding a cutting element to a downhole drilling tool, comprising:
orienting an induction coil with respect to a cutting element pocket;
applying an energy input to the induction coil to heat the cutting element pocket to a brazing temperature;
determining a pocket temperature of the cutting element pocket; and
based on the pocket temperature, controlling the energy input to the induction coil to maintain the pocket temperature at the brazing temperature for a brazing period.

2. The method of claim 1, wherein orienting the induction coil includes orienting a robotic arm, and wherein the robotic arm includes the induction coil on a working end thereof.

3. The method of claim 2, further comprising determining a heating path based on a geometry of a bit body, wherein orienting the robotic arm includes moving the induction coil along the heating path.

4. The method of claim 3, wherein the cutting element pocket is a first cutting element pocket and the pocket temperature is a first pocket temperature, and wherein a second cutting element pocket is located along the heating path, the method further comprising:
orienting the induction coil with respect to the second cutting element pocket;
applying an energy input to the induction coil to heat the second cutting element pocket to a brazing temperature;
determining a second pocket temperature of the second cutting element pocket; and
based on the second pocket temperature, controlling the energy input to the induction coil to maintain the second pocket temperature at the brazing temperature for the brazing period.

5. The method of claim 1, wherein determining the pocket temperature includes determining the pocket temperature of the cutting element pocket using an infrared camera directed at the cutting element pocket and the induction coil.

6. The method of claim 1, wherein applying the energy input includes applying the energy input to the induction coil to heat the cutting element pocket to a brazing temperature in 60 seconds or less.

7. The method of claim 1, wherein controlling the energy input to the induction coil includes decreasing an electrical energy input to the induction coil to maintain the pocket temperature at the brazing temperature.

8. The method of claim 1, wherein the cutting element pocket is a first cutting element pocket and the downhole drilling tool includes a second cutting element pocket, the method further comprising applying an energy input to the induction coil to heat the first cutting element pocket and the second cutting element pocket to a preliminary temperature less than the brazing temperature before heating the first cutting element pocket to the brazing temperature.

9. The method of claim 1, further comprising inserting a cutting element into the cutting element pocket, the cutting element including an ultrahard portion, and wherein the method further includes:
determining an ultrahard portion temperature of the ultrahard portion; and
controlling the energy input to the induction coil to maintain the ultrahard portion temperature below 1600 ° F.

10. The method of claim 1, further comprising applying a brazing material to the cutting element pocket and inserting a cutting element into the cutting element pocket, wherein applying the energy input to the induction coil further includes applying the energy input to the induction coil to heat the cutting element pocket and the brazing material to a brazing temperature without using a flux material.

11. The method of claim 10, wherein the brazing temperature is below a critical temperature of 1600° C.

12. The method of claim 1, wherein the induction coil is a first induction coil, the method further comprising:
orienting the first induction coil adjacent to a first side of the cutting element pocket;
orienting a second induction coil adjacent to a second side of the cutting element pocket;
applying an energy input to the first induction coil and the second induction coil to heat the cutting element pocket to a brazing temperature; and
based on the pocket temperature, controlling the energy input to the first induction coil and the second induction coil to maintain the pocket temperature at the brazing temperature for the brazing period.

13. The method of claim 12, further comprising inserting a cutting element into the cutting element pocket, the cutting element including an ultrahard portion on a distal end of the cutting element, the distal end being oriented adjacent to a third side of the cutting element pocket opposite the first side, the method further including applying an energy input to the first induction coil and the second induction coil to heat the cutting element pocket from the first side and the second side.

14. A method of bonding a cutting element to a downhole drilling tool, comprising:
applying a brazing material to a cutting element pocket;
inserting a cutting element into the cutting element pocket;
orienting a robotic arm with respect to the cutting element pocket, the robotic arm including an induction coil;
orienting the induction coil adjacent to the cutting element pocket;
applying an energy input to the induction coil to heat the cutting element pocket to a brazing temperature;
while at the brazing temperature, melting the brazing material; and
after melting the brazing material, seating the cutting element into the cutting element pocket while maintaining an angular orientation of the cutting element.

15. The method of claim 14, wherein orienting the induction coil further includes moving the induction coil along a predetermined heating path relative to the cutting element pocket.

16. A brazing system, comprising:
a support configured to support a bit including a plurality of cutting element pockets;
a robotic arm having a working end, the working end movable relative to the support;
an induction heater connected to the working end of the robotic arm; and
a thermal sensor oriented toward the support.

17. The brazing system of claim 16, wherein the thermal sensor is oriented at the support and the induction heater thermal sensor.

18. The brazing system of claim 16, wherein thermal sensor includes an infrared camera.

19. The brazing system of claim 18, wherein a field of view of the infrared camera is configured to capture an entirety of a surface of the bit.

20. The brazing system of claim 16, wherein the induction heater includes a plurality of induction coils.
